(19) United States
(12) Patent Application Publication
(10) Pub. No.: US 2003/0184601 A1
(43) Pub. Date: Oct. 2, 2003

(54) Pattern generating model and method of representing a network of relationships

(76) Inventor: Mark P. White, Bloomington, IN (US)

Correspondence Address: Michael B. McNeil, Liell & McNeil Attorneys PC, P.O. Box 2417, Bloomington, IN, 47402, US

(21) Appl. No.: 10/338,382

(22) Filed: Jan. 8, 2003

Related U.S. Application Data
(60) Provisional application No. 60/367,653, filed on Mar. 26, 2002.
(60) Provisional application No. 60/415,621, filed on Oct. 1, 2002.
(60) Provisional application No. 60/426,295, filed on Nov. 14, 2002.
(60) Provisional application No. 60/419,919, filed on Oct. 21, 2002.

(51) Int. Cl. G09G 5/00

(52) U.S. Cl. 345/854

(57) ABSTRACT

A data processor can include a hand manipulatable physical model representing a first regular polyhedron and a second regular polyhedron reorientable with respect to one another about a common center. The first regular polyhedron could be a tetrahedron, and the second regular polyhedron could be a dodecahedron. The polyhedrons are limited to reorientations via a rotation about a shared axis of symmetry. Each corner of each polyhedron is preferably identifiably different than all of the remaining comers via marking that can include colors and/or shapes. The device can be used to represent a network of relationships and/or be for processing data, such as a code in a game or otherwise.

### RELATION TO OTHER PATENT APPLICATIONS

The present application claims priority to provisional applications 60/367,653; 60/415,621; 60/419,919 and 60/426,295 that were filed on Mar. 26, 2002; Oct. 2, 2002; Oct. 21, 2002 and Nov. 14, 2002, respectively.

### TECHNICAL FIELD

The present invention relates generally to modeling networks of relationships among related pieces of information, and more particularly to a pattern generator based upon two regular polyhedrons that share a common center.

### BACKGROUND

Humans are constantly seeking to develop new tools that will enable us to better understand and manipulate the universe in which we live. Humans have long recognized that a thing or phenomenon can be better understood if a pattern can be recognized. In fact, much of science is directed to hypothesizing a pattern with regard to a phenomenon, and then constructing a test to determine whether the phenomenon exhibits a pattern of the type predicted by the hypothesis. Oftentimes, things and/or phenomena are not directly observable and thus require a model to represent the thing being studied. For instance, computers have allowed scientists to model and predict all sorts of natural phenomena from the behavior of subatomic particles to the eventual destiny of the universe. Although humanity's ability to model phenomena and recognize patterns in nature have greatly improved our understanding of the world around us, there remains great room for introducing new models to better understand the previously unexplainable, and there exists vast room for improved models to advance our understanding. Unfortunately, models are inherently imperfect, and many answers raise even more questions that we are, as yet, unable to answer. Nevertheless, humans have recognized that patterns have meaning, and patterns exist everywhere in nature and in almost everything.

The present invention is directed to a new type of pattern generating model.

### SUMMARY OF THE INVENTION

In one aspect, a data processor includes a model representing at least a portion of a first regular polyhedron and at least a portion of a second regular polyhedron. The first and second regular polyhedrons are reorientable with respect to one another about a common center.

In another aspect, a pattern generator includes a hand manipulatable physical model representing at least a portion of a first polyhedron and at least a portion of a second regular polyhedron that are reorientable with respect to one another about a common center.

In still another aspect, a method of representing a network of relationships includes a step of assigning items in a first data set to features of a first regular polyhedron. Items in a second data set are assigned to features of a second regular polyhedron. The first regular polyhedron is oriented relative to the second regular polyhedron in an orientation corresponding to at least one shared axis of symmetry.

### BRIEF DESCRIPTION OF THE DRAWINGS

FIG. 1a is an isometric view of a tetrahedron along with several of its axes of symmetry;

FIG. 1b is an isometric view of a cube along with several of its axes of symmetry;

FIG. 1c is an isometric view of a octahedron along with several of its axes of symmetry;

FIG. 1d is an isometric view of a icosahedron along with several of its axis of symmetry;

FIG. 1e is an isometric view of a dodecahedron along with several of its axes of symmetry;

FIG. 2 is an isometric view of a cube and a dodecahedron with a common center and oriented to share common axes of symmetry;

FIG. 3a is an isometric view of a tetrahedron and a dodecahedron with a common center in a first orientation with common axes of symmetry;

FIG. 3b is an isometric view of the tetrahedron and dodecahedron of FIG. 3a after being reoriented to share a different set of common axes of symmetry;

FIG. 3c is an isometric view of the tetrahedron and dodecahedron of FIGS. 3a and 3b with still another different set of shared common axes of symmetry;

FIG. 4 is an isometric view of a hand manipulatable physical model representing a tetrahedron and a dodecahedron that are reorientable with respect to one another about a common center;

FIG. 5 is an isometric view of the spherical core for the dodecahedron of FIG. 4 with a single face of the dodecahedron attached;

FIG. 6 is an exploded view of the dodecahedron face assembly shown in FIG. 5;

FIG. 7 is a top view of the color pattern for one of the faces of the dodecahedron shown in FIG. 4.

FIG. 8 is an isometric view of the dodecahedron portion of the pattern generator of FIG. 4 with all but two faces attached to the central globe;

FIG. 9 is an isometric view of the tetrahedron portion of the pattern generator of FIG. 4.

FIGS. 10a-h are symbolic representations of different orientations of the pattern generator of FIG. 4.

### DETAILED DESCRIPTION

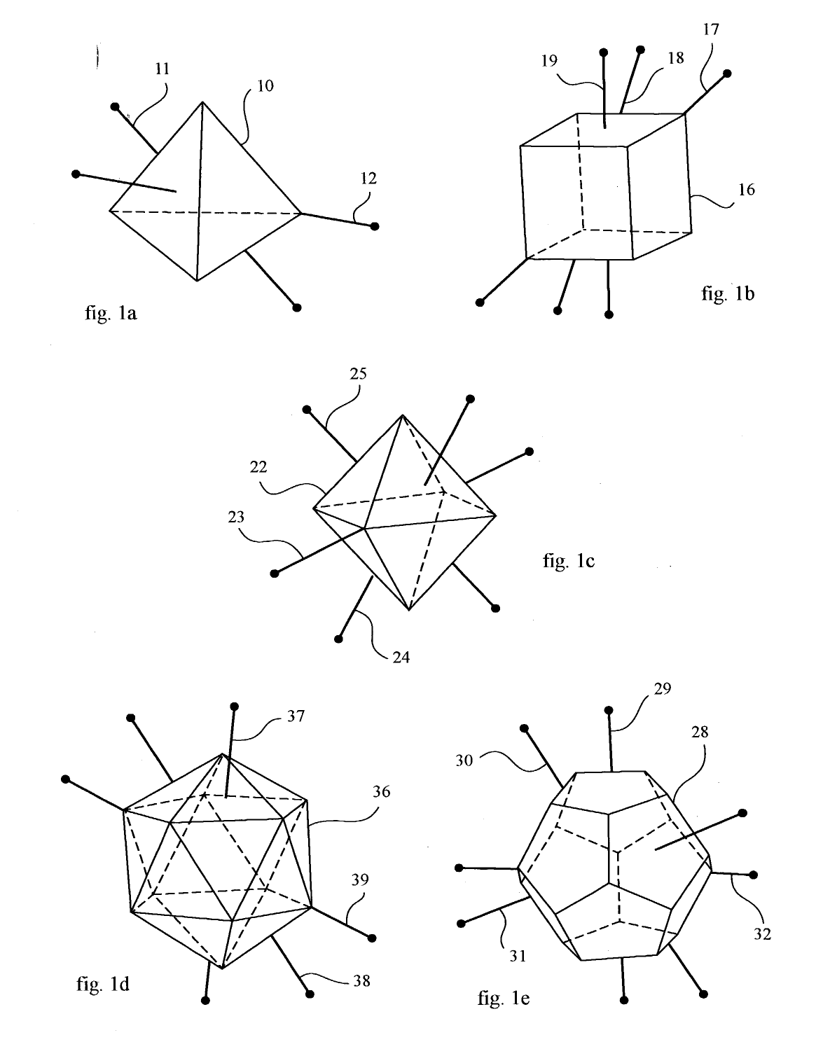

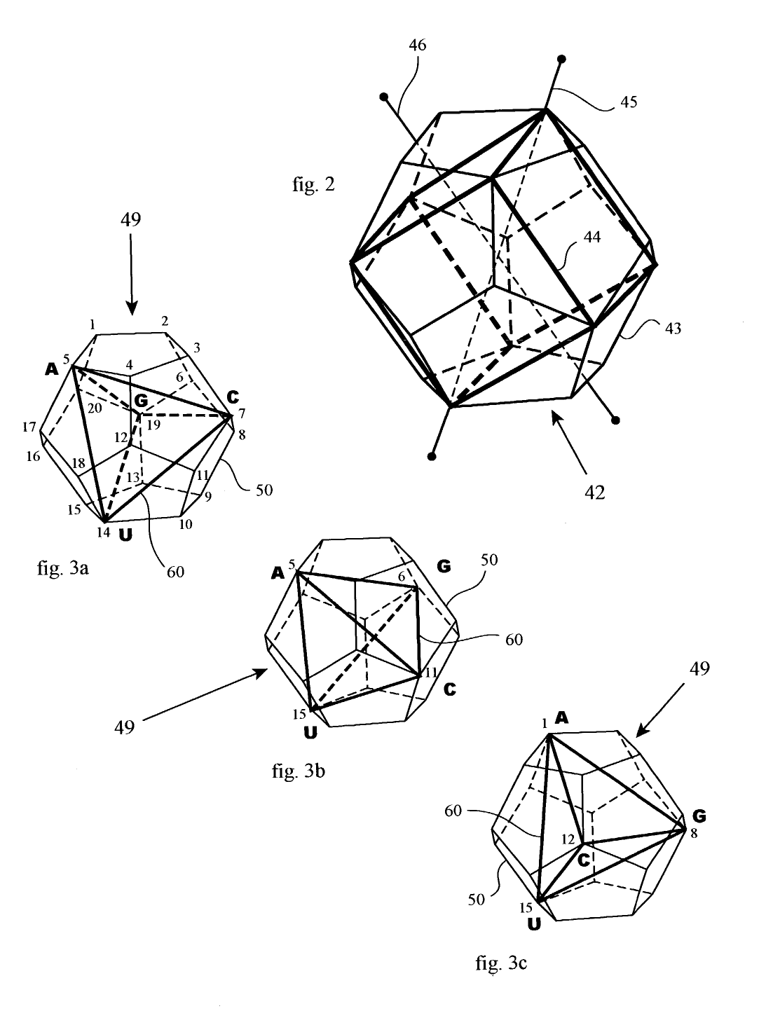

Referring to FIGS. 1a-d, each of the five regular polyhedrons are illustrated along with several of their respective axes of symmetry. There are only five regular polyhedrons, which are sometimes referred to as platonic solids. FIG. 1a shows a tetrahedron 10 that consists of four identical equilateral triangular faces and four corners or vertices. Tetrahedron 10 has a first set of rotational axes of symmetry 11 that pass through opposite edges of the tetrahedron, and a second set of rotational axes of symmetry 12 that pass through a corner and the center of an opposing face. Those skilled in the art will appreciate that any 180° rotation about an axis of symmetry 11 will leave the tetrahedron in an orientation indistinguishable from that which it preceded its rotation. In addition, any 120° rotation about an axis of symmetry 12 will also result in an orientation that is indistinguishable from that orientation that preceeded the rotation. Those skilled in the art will also recognize that the dual of tetrahedron 10 is another tetrahedron. Dual, in this context, means that if each corner were replaced with a face, and each face with a corner, a new regular polyhedron would be formed, and that polyhedron would be another tetrahedron. Thus, tetrahedron 10 includes four faces, four corners and six edges, and a tetrahedron for a dual.

FIG. 1b shows a familiar cube 16 which consists of six square faces. Cube 16 has a first set of rotational axes of symmetry 17 that extend between opposite corners, a second set of rotational axes of symmetry 18 that extend between the middle of opposite edges, and a third set of axes of symmetry 19 that extend through the center of opposite faces of cube 16. A cube includes six faces, eight corners and twelve edges. The dual of cube 16 is an octahedron 22 as shown in FIG. 1c. In other words, the dual of the cube replaces each corner with a face, and each face with a corner, to produce another regular polyhedron. Thus, as expected, octahedron 22 has eight faces which correspond to the eight corners of cube 16, and six comers that correspond to the six faces of cube 16. Like all regular polyhedrons, octahedron 22 includes several different sets of rotational axes of symmetry. A first set of axes of symmetry 23 extend between opposite corners of octahedron 22. A second set of rotational axes of symmetry 24 extend between centers of opposite faces, and a third set of axes of symmetry 25 extend between the middles of opposite edges of octahedron 22. A regular polyhedron and its dual share common axes of symmetry.

Referring now to FIG. 1d, an icosahedron 36 includes twenty equilateral triangular faces and twelve corners. Like the other regular polyhedrons, icosahedron 36 includes a first set of rotational axes of symmetry 37 that pass through the centers of opposite faces, a second set of rotational axes of symmetry 38 that pass through the middle of opposing edges, and a third set of axes of symmetry 39 that pass through opposing corners. The dual of an icosahedron 36 is a dodecahedron 28 as shown in FIG. 1e. Thus, dodecahedron 28 includes twelve faces, which correlate to the twelve comers of icosahedron 36, and twenty comers, which correspond to the twenty faces of icosahedron 36. Dodecahedron 28 includes at least three different sets of axes of symmetry 29-31. A first set of axes of symmetry 29 extend through opposite corners, a second set of axes of symmetry 30 extend between the middle of opposing edges, and a third set of axes of symmetry 31 extend between the centers of opposing faces. In addition, dodecahedron 28 includes at least one other set of axes 32 that extend between opposing centers of a cord through opposing pentagonal faces. A 180° rotation about an axes 32 produces a mirror image of the orientation before a rotation. Those skilled in the art will appreciate that there may be more sets of axes than those identified in the previous discussion with regard to FIGS. 1a-d and that exhibit special properties. Those skilled in the art will also appreciate that any of the regular polyhedrons can be projected onto a sphere, in which case each edge of the regular polyhedron becomes a segment of a great circle on the sphere and each comer becomes a point on the sphere.

Although each of the regular polyhedrons are uniquely interesting in their own right, a very irregular relationship is created when two regular polyhedrons are superimposed upon one another in a way in which they share a common center as shown in FIG. 2. FIG. 2 shows a model 42 with a dodecahedron 43 and a cube 44 sharing a common center. Those skilled in the art will recognize that cube 44 and dodecahedron 43 share numerous different, but related, common axes of symmetry in each of many different orientations of cube 44 with respect to dodecahedron 43. For instance, probably the easiest common axes of symmetry to see are a set of axes of symmetry 45 that extend through opposite corners of both dodecahedron 43 and cube 44. In addition, another set of common axes of symmetry 46 extend through the centers of opposite faces of cube 44 and through the middle of certain pairs of edges of dodecahedron 43. The axes of symmetry through the edges of cube 44 are aligned with some of the mirror axes 32 (FIG. 1e) identified earlier. Thus, in each orientation of cube 44 with respect to dodecahedron 43, every corner to corner and face to face axis of symmetry of cube 44 is also an axis of symmetry of dodecahedron 43. However, there are many axes of symmetry of the dodecahedron that are not shared in common with cube 44. Thus, one could orient a cube with respect to a dodecahedron with common centers in a number of different ways in which certain axes of symmetry of the cube are shared in common with different subsets of axes of symmetry of dodecahedron 43. These orientations are related, and can be exploited to represent a network of relationships.

Those skilled in the art will appreciate that any two of the regular polyhedrons can form a unique set of relationships similar to that described with respect to cube 44 and dodecahedron 43 shown in the model 42 of FIG. 2. Although these two regular polyhedrons could be of the same type, many interesting relationships appear to occur when the two regular polyhedrons are different. It is also interesting to note that another different set of relationships can be created when one of the regular polyhedrons has its dual substituted. For instance, an octahedron could be substituted in place of cube 44 to create a new network of relationships among various orientations of the octahedron relative to the dodecahedron 43. In addition, both of the regular polyhedrons could have their dual substituted in place to create even more networks of relationships. For instance, a dual of the model 42 shown in FIG. 2 would have an octahedron and an icosahedron sharing a common center, and each of these different models would be related to the others via the duality of the regular polyhedrons.

Referring now to FIGS. 3a-c, a model 49 is made even more interesting by uniquely identifying each corner of each of the two regular polyhedrons. In this case, a tetrahedron 60 shares a common center with a dodecahedron 50. Each comer of tetrahedron 60 is uniquely identified with one of four letters A, G, C or U. Each comer of dodecahedron 50 has a unique identifier with the numbers 1-20. It is interesting to note that every rotational axis of symmetry of tetrahedron 60 is also a rotational axis of symmetry of dodecahedron 50, but not vice versa. Thus, each of the FIGS. 3a-3c show tetrahedron 60 sharing a different subset of common axes of symmetry with dodecahedron 50. However, these different subsets are related to one another. For instance, the orientation of model 49 shown in FIG. 3a can be transformed into the orientation of FIG. 3b simply by rotating tetrahedron 60 about its axis of symmetry that passes through comer A. The orientations of FIGS. 3b and 3c are related via a rotation of tetrahedron 60 relative to dodecahedron 50 about an axis of symmetry passing through comer U of tetrahedron 60. Thus, to move from the orientation of FIG. 3a to FIG. 3c, the tetrahedron 60 is first rotated about the axis of symmetry passing through comer A and then rotated about an axis of symmetry passing through corner U.

Those skilled in the art will appreciate that there are 120 different ways to orient tetrahedron 60 with respect to dodecahedron 50 in which every axis of symmetry of tetrahedron 60 is also a subset of the axes of symmetry of dodecahedron 50. It is also important to note that each of these different orientations can be reached from any other orientation in six or less rotations of tetrahedron 60 about one of its comer axes of symmetry. Each of these different orientations can be easily described by identifying two comers of the tetrahedron that are shared in common with two corners of dodecahedron 50. For instance, the orientation of model 49 of FIG. 3a could be described as A5-C7, or possibly U14-G19. The orientation of FIG. 3b could be described as A5-G6, or possibly be described in terms of the orientation of 3a plus a rotation about the axis of symmetry through corner A of tetrahedron 60.

The present invention refers to these different related relationships as a network of relationships that is somewhat irregular, yet defined by a relationship between two regular polyhedrons. For instance, the model 49 illustrated in FIGS. 3a-3c might be useful in modeling the network of relationships between the four MRNA base codes that appear in the genetic code and the twenty amino acids that make up the building blocks of almost all life as we know it. In other words, each of the twenty comers of dodecahedron 50 could represent one of the twenty amino acids, and each of the four comers of tetrahedron 60 could correspond to the DNA or MRNA base codes. Thus, model 49 could possibly be structured in a way to process and explore relationships between nucleic acids and amino acids.

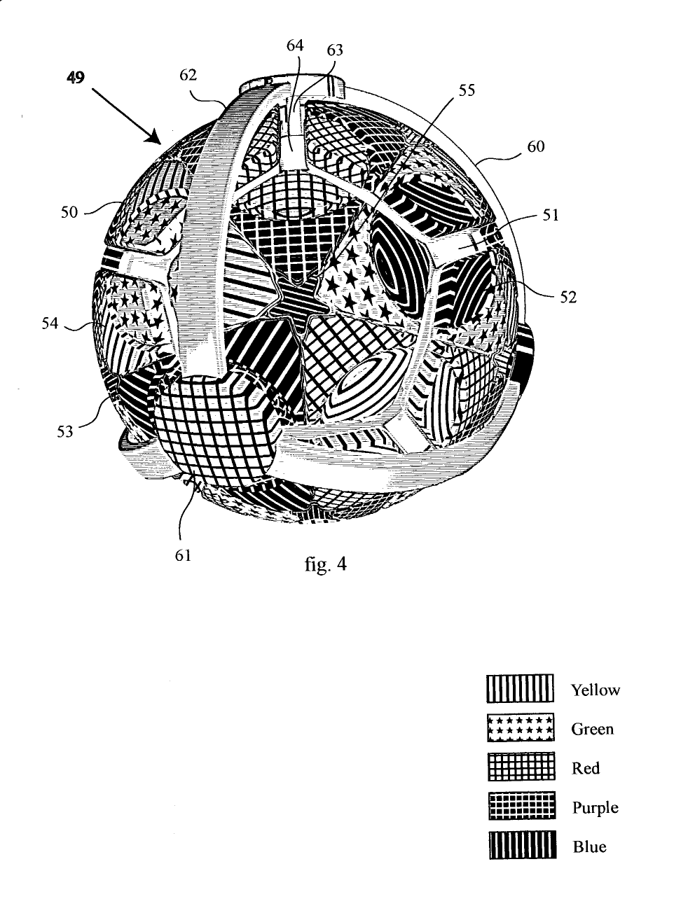

Referring now to FIG. 4, a hand manipulateable physical model 49 represents a dodecahedron 50 reorientable with respect to a tetrahedron 60 about a common center. Those skilled in the art will recognize that dodecahedron 50 and tetrahedron 60 are projected onto inner and outer spherical surfaces respectively. Thus, in this embodiment, dodecahedron 50 can be considered as an inner structure and tetrahedron 60 can be considered an outer structure. An interconnection between the inner and outer structures permits different orientations between dodecahedron 50 and tetrahedron 60. This interconnection includes guide paths 51 that are arranged to correspond to the edges of dodecahedron 50, and four separate path followers 63 of tetrahedron 60 are trapped to move within guide paths 51. Thus, this interaction limits reorientation to a rotation about an axis of symmetry through one of the corners of tetrahedron 60. Nevertheless, those skilled in the art will appreciate that the interaction between the inner and outer structure need not be limiting in this manner. In other words, the inner structure could be simply a sphere with markings representing a dodecahedron and the outer structure could be free to move about that spherical surface without constraints. In any event, the interconnection preferably includes a spherical interface.

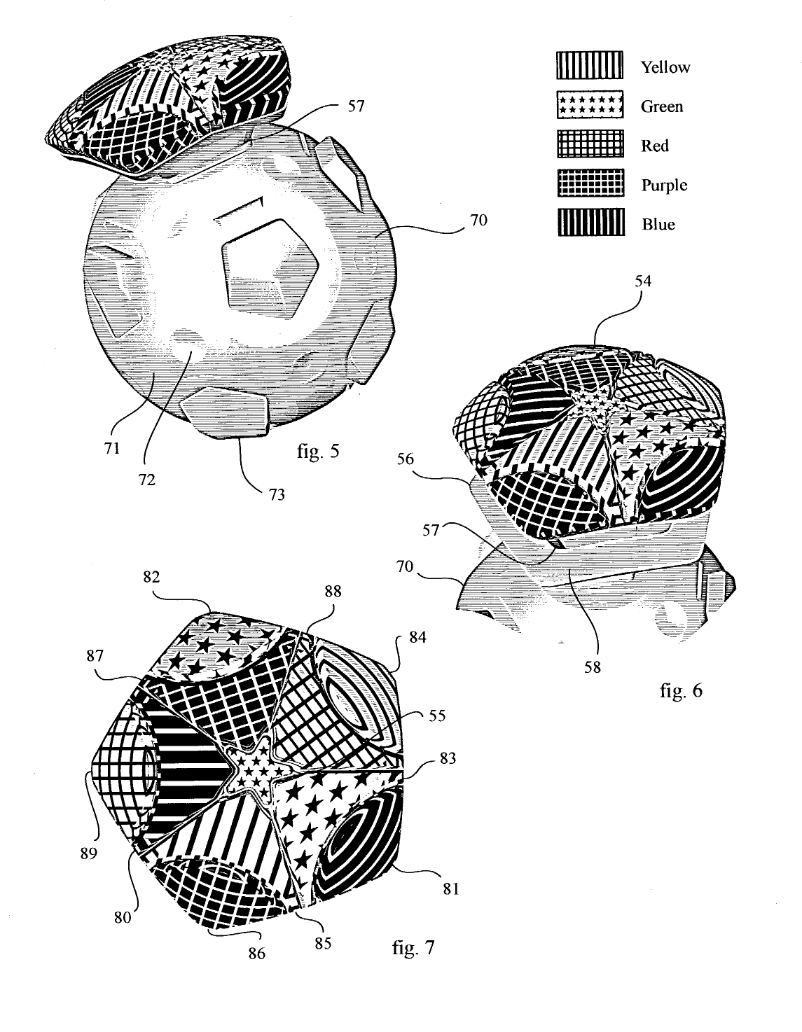

Tetrahedron 60 includes four vertexes or corners 61 that are marked in a way to make them individually identifiable. In the embodiment of FIG. 4, each vertex 61 is identified with a different color. In this case, the colors red, blue, green and yellow. Each of the vertexes are connected via a vertex connector 62, which correspond to the edges of tetrahedron 60. Each vertex 61 has attached thereto a radially inward pointing path follower 63 that terminates in a bearing 64 that moves about on a core sphere 70 that is best seen in FIG. 5. The interaction between bearings 64 and core sphere 70 can be considered a spherical interface. Tetrahedron 60 can be manufactured in a number of ways from a variety of different materials, but is preferably manufactured from separate components that are glued or otherwise attached to one another in any suitable fashion.

The hand manipulateable model 49 of FIG. 4 is preferably constructed in a manner illustrated in FIGS. 5-9. In particular, a central core sphere 70 is molded or machined to include a generally spherical surface with twelve protuberances 73 distributed about the sphere in a pattern corresponding to a dodecahedron. A separate pentagonal face 54 is mounted on each protuberance 73. Core sphere 70 also preferably includes twenty detents 72 that receive ball bearings 65 which are mounted in bearings 64 of tetrahedron 60 as shown in FIG. 9. The interaction between ball bearing 65 and detents 72 are desirable but not necessary. The interaction between ball bearing 65 and detents 72 render each of the orientations of special interest stable. These orientations of special interest are those in which every axis of symmetry of tetrahedron 60 is also an axis of symmetry of dodecahedron 50.

Each pentagonal face 54 of dodecahedron 50 includes a face with unique markings attached to a glue surface 58 of a face support 56, which is a portion of a hollow pedestal 57. The hollow pedestal 57 is preferably formed to mate with an individual protuberance 73 that is formed on the outer surface of core sphere 70. There are nearly a limitless number of ways to apply markings to dodecahedron 50 so that each comer or vertex of dodecahedron 50 is identifiably different than all of the other vertexes. In the embodiment illustrated, this is accomplished using five different colors arranged generally in the pattern shown in FIG. 7. However, it is important to note that each face 54 of dodecahedron 50 includes a similar looking but different pattern of colors such that each of the twelve pentagonal faces is similar but different from all of the other pentagonal faces. The five colors used in this embodiment are red, green, yellow, blue and purple. Each pentagonal face 54 includes a blue triangle fragment 80, a green triangle fragment 83, a yellow triangle fragment 85, a purple triangle fragment 87, and a red triangle fragment 88. In addition, each pentagonal face 54 includes a blue circle fragment 81, a green circle fragment 82, a yellow circle fragment 84, a purple circle fragment 86 and a red circle fragment 89. Each of the pentagonal faces 54 has the triangle and circle fragments arranged in one of twelve different permutations corresponding to the twelve faces of dodecahedron 50. In the illustrated embodiment, each pentagonal face 54 also includes a central star shape marking 55 that is colored in one of the four colors of the outer tetrahedron 60. The color chosen is that of the circle fragment for the pentagonal face that is surrounded by the purple triangular fragment. Thus, in FIG. 7 star 55 is red corresponding to red circle fragment 89 that is adjacent purple triangle fragment 87. When the pentagonal faces 54 are attached to core sphere 70 to produce the hand manipulateable model 49 of FIG. 4, each vertex of dodecahedron 50 corresponds to a vertex circle 52 and a triangle 53. Each of these vertexes has a unique combination of a colored circle 52 and a colored triangle 53. For instance, referring to FIG. 4, there is only one vertex that includes a blue circle surrounded by a green triangle. When properly arranged, the pentagonal faces will be such that the purple triangles will be arranged in a tetrahedral pattern on dodecahedron 50 such that the colored vertex 61 of tetrahedron 60 can be made coincident with the four colored circles of the four purple triangles. Those with skill in the art will recognize that the triangles can be thought of as producing an icosahedron which is the dual of the dodecahedron 50. The colored stars 55 can be useful in uniquely identifying each (vertex) of the dual icosahedron from its other vertices.

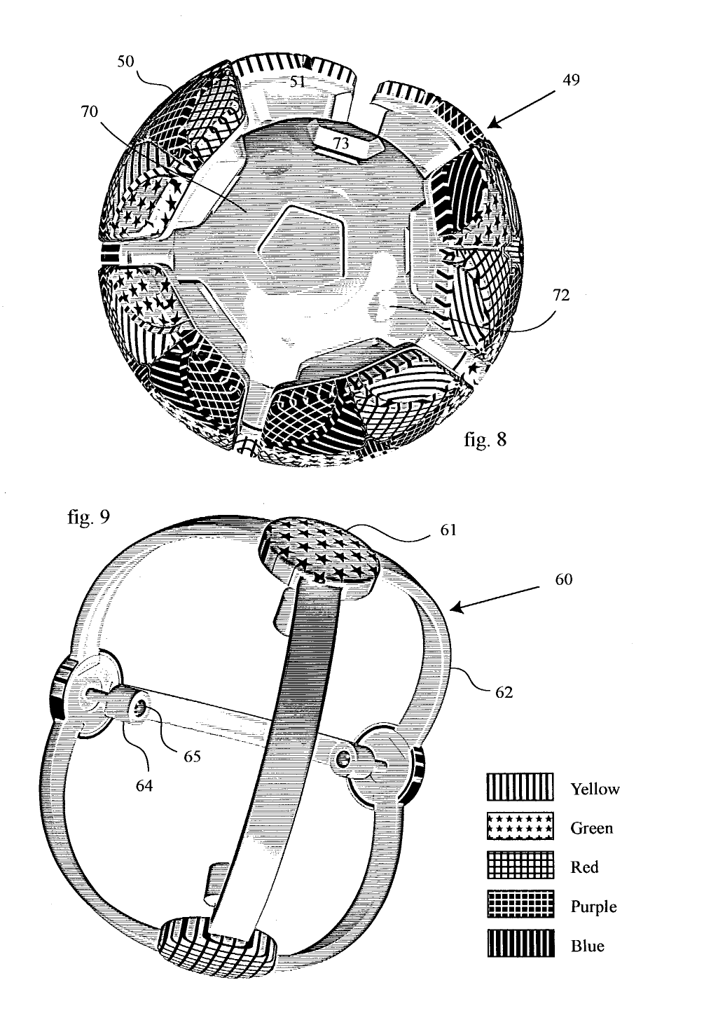

One manner of constructing the device would be to attach ten of the twelve pentagonal faces to the central spherical core 70 as shown in FIG. 8. Next, the tetrahedron is preferably assembled in stages around the partial dodecahedron. This is preferably accomplished by first attaching a separate vertex 61 of tetrahedron 60 to a separate vertex connector 62 so that there are four vertex-connector subassemblies. Next, two of these subassemblies are connected to one another using an additional connector 62. There are two different configurations for the partially assembled tetrahedron 60. One of each is preferably made. Next, one of the partial tetrahedron assemblies is placed on the dodecahedron 50. This subassembly is then rotated away from the opening created by the two pentagonal faces that have been left unattached to the dodecahedron 50. Next, the second partial tetrahedron subassembly is placed on the dodecahedron. The two tetrahedron subassemblies are then attached to one another to form the full tetrahedron 60. Next, the colored vertices are attached to the vertices 61 of tetrahedron 60 so that each is identifiably different from the other three vertices. Finally, the two remaining pentagonal faces are attached to complete the dodecahedron. The tetrahedron 60 is then trapped to move about dodecahedron 50 in the manner previously described.

### APPLICABILITY

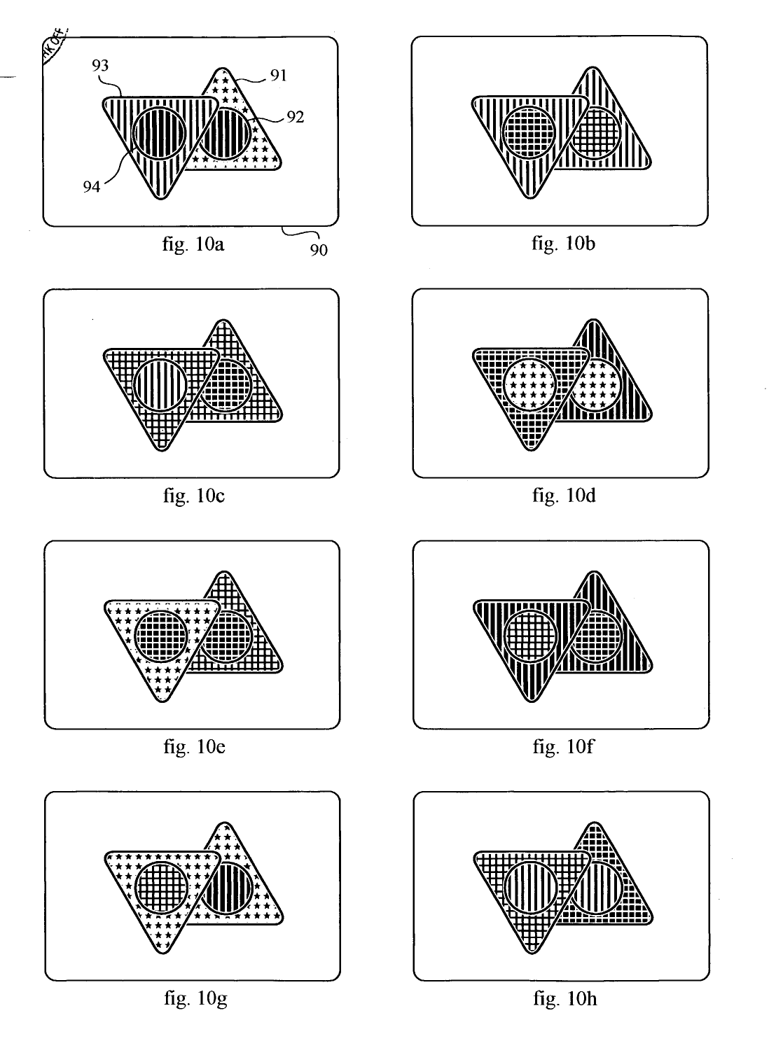

One manner in which the model of the present invention could be used is in a game. For instance, each player could be timed in how long it takes them to reorient tetrahedron 60 with respect to dodecahedron 50 from one orientation to another of the 120 different orientations. There are many ways to identify each of these different orientations, and innumerable ways to move between any two orientations. One way to identify orientations could be to produce cards that identify where two of the vertices of tetrahedron 60 are located with respect to the vertexes of dodecahedron 50. As stated earlier, each vertex of dodecahedron 50 can be uniquely identified by a color combination triangle and circle. Once two of the vertices of tetrahedron are identified with respect to vertices of the dodecahedron, the location of the other two vertices of the tetrahedron are determinable. Referring now to FIGS. 10a-h, example cards for the competitive game previously described are illustrated. Each data card 90 could include a primary vertex triangle 91 that encloses a primary vertex circle 92. In addition, each data card 90 could include a secondary vertex triangle 93 and a secondary vertex circle 94. If one arbitrarily assigns the green vertex of the tetrahedron 60 to correspond with the primary vertex triangle and circle 91, 92 then data card 90 of FIG. 10a would correspond to the green vertex of tetrahedron 60 being positioned over the green triangle with blue circle of dodecahedron 50. If one arbitrarily assigns the secondary vertex triangle and circle 93, 94 with the red vertex of tetrahedron 60, the red vertex of the tetrahedron 60 would be aligned with the purple triangle with blue circle on dodecahedron 50. Thus, data card 90 of FIG. 10a places the green vertex of tetrahedron 60 over the green triangle with blue circle vertex of dodecahedron 50, and the red vertex of tetrahedron 60 over the purple triangle with blue circle vertex of dodecahedron 50. Those skilled in the art will recognize that this inherently assigns the blue vertex of tetrahedron 60 to the yellow triangle with blue circle of dodecahedron 50. In addition, that data card inherently assigns the yellow vertex of tetrahedron 60 to the red triangle with blue circle vertex of dodecahedron 50. Thus, if desired, the game could be played by first turning over a card with two colored dots on it which could represent the primary and secondary vertices of the tetrahedron. The next card could correspond to ones of the type shown in FIGS. 10a-h that show where those two vertices of the tetrahedron should be aligned with regard to the dodecahedron 50. Players could be timed in how quickly they can make the model assume the orientation defined by the cards, or they might race one another to that orientation with the winner being the first one to arrive at the defined orientation. As suggested by the sample cards of FIGS. 10a-b, different orientations correspond to different patterns. The meaning of these patterns depends on what the markings represent.

Although the embodiment illustrated in FIG. 4 shows the tetrahedron vertices identifiably different via four different colors and the dodecahedron 50 marked with triangles and circles of five different colors, those skilled in the art will appreciate that other networks of relationships can be revealed based upon how one chooses to apply markings to the respective tetrahedron and dodecahedron. For instance, those skilled in the art might recognize that if only two colors were chosen, such as black and white, the I-Ching could even be mapped onto the model 49 of FIG. 4 to produce a whole new network of relationships that contrast with those produced by the marking scheme of FIG. 4. Those skilled in the art will appreciate that a nearly unlimited number of pattern generators can be created by, for instance, how many colors one chooses to use in marking the tetrahedron and dodecahedron.

Another possible use of the pattern generating model is possible as an encoding and/or decoding device. For instance, each of the 120 different orientations could be assigned a different characters for use in a code. A message could be encoded by defining an initial orientation and then sequentially identifying vertices of the tetrahedron about which rotations must be made in order to arrive at each consecutive orientation corresponding to a character in the message. The code could be set up such that the specific orientation corresponding to the desired letter is indicated by the rotation vertex being repeated. Thus, if each vertice of the tetrahedron were assigned a unique letter such as A, G, C and U, an encoded message could appear as such: AGCCU AGUCCAUUCGAACUUGAUGCAACGGU. Those skilled in the art will recognize that because each orientation can be reached from any other orientation in six or less rotations, each successive character in an encoded message could be defined in many different ways. Thus, those skilled in the art will appreciate that the same message could be encoded in a virtually unlimited number of different ways that would look very different from one another. Thus, depending on how it is used, the model of the present invention could also be considered a data processor for processing cards for a game, or possibly processing a message for encoding or decoding. Depending on how a code is established, such as including common words assigned to neighbor orientations, the invention may be able to encode and compress data or a message.

Another possible use of the model would be in representing a network of relationships. This could be accomplished by first assigning items in a first data set to features of a first regular polyhedron, such as tetrahedron 60. Next, items in a second data set are assigned to features of the second regular polyhedron, such as the vertices of the dodecahedron. Each different orientation in which the regular polyhedrons share a common axis of symmetry would represent one of a network of different relationships between the first data set and the second data set. For instance, the first data set might be DNA or MRNA base codes. The second data set might be the twenty different amino acids that make up almost all life. Those skilled in the art will appreciate that the illustrated model shows the individual data sets as being represented by different combinations of colors and shapes. For instance, the green triangle with a blue circle could be assigned to cysteine.

Model 49 of FIG. 4 could also be used for demonstrating relationships between adjacent amino acids and their peptide bond in a protein. The cis or trans configuration of the peptide bond can be modeled respectively by noting that a vertex 61 of tetrahedron 60 can be aligned with a particular vertex of dodecahedron 50 in six different orientations. These six orientations can be divided into three groups of two orientations each. Model 49 reflects this grouping by the fact that each different orientation of a particular vertex 61 aligned with a-vertex of dodecahedron 50 has one adjacent similar orientation. These adjacent orientations are found via a rotation about an axis of symmetry through the vertex 61 of interest. Thus, these adjacent pairs of orientations can be thought of as representing the cis or trans configuration of a peptide bond. In addition, those skilled in the art will recognize that the configuration of a peptide bond is also influenced by the combined rotational orientation of the attached ammonia or carboxyl group that typically assume one of three preferred angular orientations. These three preferred orientations could correspond to the three different groups of two orientations possible for tetrahedron 60 with regard to dodecahedron 50 when they share a common vertex in all six different orientations. Since molecules talk the language of shapes, the model of the present invention should be useful in modeling various aspects of chemistry and biochemistry.

Although the present invention has been illustrated in the context of a hand manipulateable physical model, those skilled in the art will appreciate that the model of the present invention could also be created in a virtual computer space, such as by modeling each of the regular polyhedrons as a collection of joined vectors. For instance, a tetrahedron could be modeled via four vectors with a common origin and terminating at each comer of the tetrahedron. Thus, the model of the present invention can take a wide variety of forms including mathematical models of the model generally illustrated in FIGS. 3a-c, in a virtual computer model or possibly as a hand manipulateable physical model of the type shown in FIG. 4. In addition, the present invention has a virtually limitless number of potential applications limited only by the user's imagination in identifying a first data set with regard to features of the first regular polyhedron and a second data set with regard to features of the second regular polyhedron. Although the invention has been illustrated as associating the data sets with the vertices of the respective regular polyhedrons, those skilled in the art will appreciate that the faces and edges of the regular polyhedrons could also be uniquely identified in a similar manner. In addition, although the present invention has been illustrated primarily in the context of a dodecahedron and a tetrahedron, those skilled in the art will appreciate that any two regular polyhedrons could be modeled in a way in which they share a common center and can be reoriented with respect to one another. Thus, those skilled in the art will appreciate that the previous description and illustrations are merely illustrated examples. In other words, one could depart greatly from what has been shown and still fall within the scope of the present invention intended by the claims set forth below.

What is claimed is:

1. A data processor comprising:
a model representing at least a portion of a first regular polyhedron and at least a portion of a second regular polyhedron that are reorientable with respect to one another about a common center.

2. The data processor of claim 1 wherein said model includes at least one of a hand manipulatable physical model, a virtual model in a computer generated space, and a mathematical model.

3. The data processor of claim 1 wherein said first and second regular polyhedrons have a plurality of different orientations; and
said first regular polyhedron and said second regular polyhedron have a plurality of common axes of symmetry in each of said different orientations.

4. The data processor of claim 1 wherein said model limits a reorientation of said first regular polyhedron relative to said second regular polyhedron to a rotation about a common axis of symmetry.

5. The data processor of claim 1 wherein at least one of said first and second regular polyhedrons is a tetrahedron.

6. The data processor of claim 1 wherein at least one of said first and second regular polyhedrons is a dodecahedron.

7. The data processor of claim 1 wherein at least one of said first and second regular polyhedrons is marked in a predetermined pattern.

8. The data processor of claim 7 wherein said predetermined pattern includes circles, triangles and five colors.

9. The data processor of claim 1 wherein said first regular polyhedron is a tetrahedron;
said second regular polyhedron is a dodecahedron; and
each comer of said tetrahedron being identifiably different from its other comers.

10. The data processor of claim 1 wherein each comer of said first and second regular polyhedrons is identifiably different than all remaining corners of said first and second regular polyhedrons.

11. The data processor of claim 1 including detents between said first regular polyhedron and said second regular polyhedron at relative orientations where said first regular polyhedron and said second regular polyhedron share a plurality of axes of symmetry.

12. The data processor of claim 1 wherein said first regular polyhedron is a tetrahedron;
said second regular polyhedron is a dodecahedron;
said first and second regular polyhedrons have a plurality of different orientations;
said first regular polyhedron and said second regular polyhedron have a plurality of common axes of symmetry in each of said different orientations;
said model includes a hand manipulatable physical model that limits a reorientation of said first regular polyhedron relative to said second regular polyhedron to a rotation about a common axis of symmetry; and
each comer of said first and second regular polyhedrons is identifiably different than all remaining corners of said first and second regular polyhedrons.

13. A pattern generator comprising:
a hand manipulatable physical model representing at least a portion of a first regular polyhedron and at least a portion of a second regular polyhedron reorientable with respect to one another about a common center.

14. The pattern generator of claim 13 wherein said model includes an interconnection between an inner structure and an outer structure; and
said interconnection permitting a plurality of different orientations between said inner structure and said outer structure.

15. The pattern generator of claim 14 wherein said interconnection includes a spherical interface.

16. The pattern generator of claim 14 wherein said first regular polyhedron and said second regular polyhedron have a plurality of axes of symmetry in each of said different orientations.

17. The pattern generator of claim 14 wherein said interconnection limits reorientation of said inner structure relative to said outer structure to adjacent orientations that share a common axis of symmetry for said first and second regular polyhedrons.

18. The pattern generator of claim 14 wherein said interconnection limits reorientation of said inner structure relative to said outer structure to a rotation about a common axis of symmetry of said first and second regular polyhedrons.

19. The pattern generator of claim 14 wherein said interconnection includes a plurality of intersecting guide paths, and a plurality of path followers guided in said guide paths.

20. The pattern generator of claim 14 wherein at least one of said inner structure and said outer structure include markings whose relative orientations define said different orientations.

21. The pattern generator of claim 20 wherein said markings include circles, triangles and a plurality of colors.

22. The pattern generator of claim 14 wherein said outer structure corresponds to said tetrahedron; and
said inner structure corresponds to a dodecahedron.

23. The pattern generator of claim 13 including at least one tangible medium having at least a portion of a code thereon; and
each said code defining an identifiably different orientation of said first regular polyhedron relative to said second regular polyhedron.

24. The pattern generator of claim 13 wherein at least one of said first regular polyhedron and said second regular polyhedron is projected onto a sphere.

25. A method of representing a network of relationships, comprising the steps of:
assigning items in a first data set to features of a first regular polyhedron;
assigning items in a second data set to features of a second regular polyhedron; and
orienting the first regular polyhedron relative to the second regular polyhedron in an orientation corresponding to at least one shared axis of symmetry.

26. The method of claim 25 including a step of positioning the first regular polyhedron and a second regular polyhedron to share a common center.

27. The method of claim 26 including a step of constraining a reorientation of the first regular polyhedron to the second regular polyhedron to a rotation about a common axis of symmetry.

28. The method of claim 27 wherein said first data set and said second data set are represented by at least one of shapes and colors.

29. The method of claim 26 wherein one of said first regular polyhedron and said second regular polyhedron is a tetrahedron; and
an other of said first regular polyhedron and said second regular polyhedron is a dodecahedron.

30. The method of claim 26 including a step of projecting at least one of said first regular polyhedron and said second regular polyhedron onto a sphere.
